(19) United States
(12) Patent Application Publication
(10) Pub. No.: US 2011/0198517 A1
(43) Pub. Date: Aug. 18, 2011

(54) OPTICAL-LEVER CANTILEVER DISPLACEMENT DETECTING MECHANISM

(75) Inventor: Toshihiro YOSHII, Hachioji-shi (JP)

(73) Assignee: OLYMPUS CORPORATION, Tokyo (JP)

(21) Appl. No.: 13/025,209

(22) Filed: Feb. 11, 2011

(30) Foreign Application Priority Data
Feb. 18, 2010 (JP) 2010-033888

(51) Int. Cl. G01C 9/06

(52) U.S. Cl. 250/552; 250/215

(57) ABSTRACT

An optical-lever cantilever displacement detecting mechanism includes a support member, a cantilever cantilevered by the support member, a light source to emit a light beam, and an optical sensor to sense the light beam. The cantilever has a probe at its tip. The support member has a reflecting portion extending to face the cantilever with a space. The reflecting portion has a light transmitting portion to allow the light beam to pass therethrough. The cantilever and reflecting portion have reflecting surfaces on sides facing each other, respectively. The light beam emitted from the source undergoes repeated reflections by the reflecting surfaces of the cantilever and reflecting portion including reflections by the reflecting surface of the cantilever, passes through the light transmitting portion, and strikes the sensor. The sensor outputs a signal representing a change of the entry position of the light beam caused by a displacement of the cantilever.

### CROSS-REFERENCE TO RELATED APPLICATIONS

This application is based upon and claims the benefit of priority from prior Japanese Patent Application No. 2010-033888, filed Feb. 18, 2010, the entire contents of which are incorporated herein by reference.

### BACKGROUND OF THE INVENTION

1. Field of the Invention

The present invention relates to an optical-lever cantilever displacement detecting mechanism for detecting a displacement of a cantilever.

2. Description of the Related Art

An optical-lever cantilever displacement detecting mechanism applies a light beam to a cantilever, senses the reflected light beam by an optical sensor, and detects a displacement of the cantilever as a change of the entry position of the light beam into the optical sensor, that is, as a movement of a beam spot on the optical sensor.

The movement amount of the beam spot corresponding to the displacement of the cantilever is greater when the optical path length from the cantilever to the optical sensor is greater. That is, when the optical sensor is located farther from the cantilever, the movement amount of the beam spot is more amplified, and detection sensitivity is thus improved.

However, when the optical sensor is located apart from the cantilever, the configuration of the optical-lever cantilever displacement detecting mechanism is increased in size. In consequence, it is difficult to dispose the optical-lever cantilever displacement detecting mechanism in a small space, and the degree of freedom in the design of equipment to incorporate this mechanism is reduced.

### BRIEF SUMMARY OF THE INVENTION

An object of the invention is to provide a small optical-lever cantilever displacement detecting mechanism with high detection sensitivity.

An optical-lever cantilever displacement detecting mechanism according to an aspect of the invention includes a support member, a cantilever cantilevered by the support member, a light source to emit a light beam, and an optical sensor to sense the light beam. The cantilever has a probe at its tip. The support member has a fixed reflecting portion extending to face the cantilever with a space from the cantilever. The fixed reflecting portion has a light transmitting portion to allow the light beam to pass therethrough. The cantilever and the fixed reflecting portion have reflecting surfaces on sides facing each other, respectively. The light beam emitted from the light source undergoes repeated reflections by the reflecting surface of the cantilever and the reflecting surface of the fixed reflecting portion including reflections by the reflecting surface of the cantilever, passes through the light transmitting portion, and strikes the optical sensor. The optical sensor outputs a signal representing a change of the entry position of the light beam caused by a displacement of the cantilever.

According to the invention, a small optical-lever cantilever displacement detecting mechanism with high detection sensitivity is provided.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a side view of an optical-lever cantilever displacement detecting mechanism according to a first embodiment of the present invention;

FIG. 2 is a front view of the optical-lever cantilever displacement detecting mechanism shown in FIG. 1;

FIG. 3 is a side view of an optical-lever cantilever displacement detecting mechanism according to a second embodiment of the present invention;

FIG. 4 is a front view of the optical-lever cantilever displacement detecting mechanism shown in FIG. 3;

FIG. 5 is a side view of an optical-lever cantilever displacement detecting mechanism according to a third embodiment of the present invention;

FIG. 6 is a side view of an optical-lever cantilever displacement detecting mechanism according to a fourth embodiment of the present invention;

FIG. 7 is a front view of the optical-lever cantilever displacement detecting mechanism shown in FIG. 6;

FIG. 8 is a side view of an optical-lever cantilever displacement detecting mechanism according to a fifth embodiment of the present invention;

FIG. 9 is a front view of the optical-lever cantilever displacement detecting mechanism shown in FIG. 8; and

FIG. 10 is a side view of an optical-lever cantilever displacement detecting mechanism according to a sixth embodiment of the present invention.

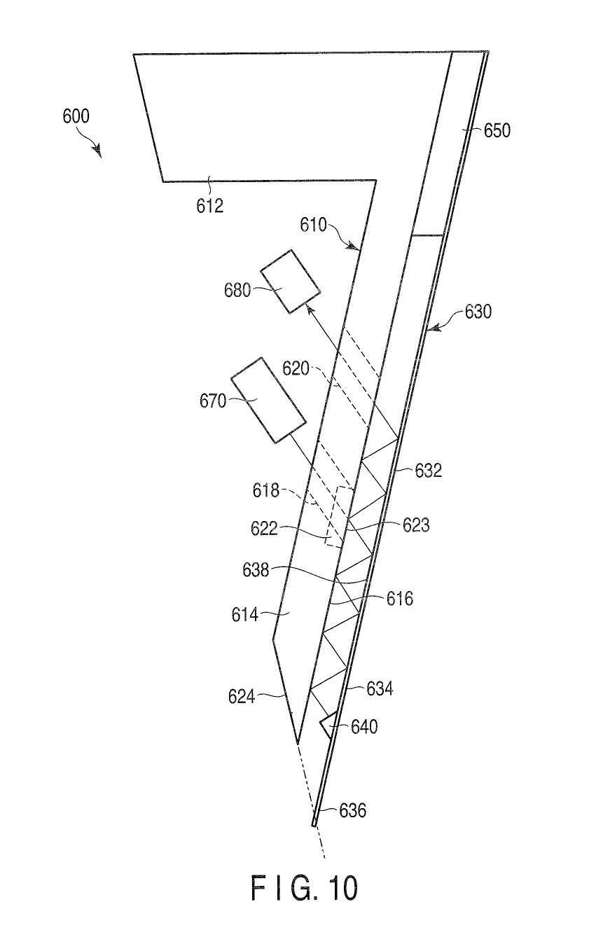

### DETAILED DESCRIPTION OF THE INVENTION

An optical-lever cantilever displacement detecting mechanism according to embodiments of the present invention will be described hereinafter with reference to the drawings.

### First Embodiment

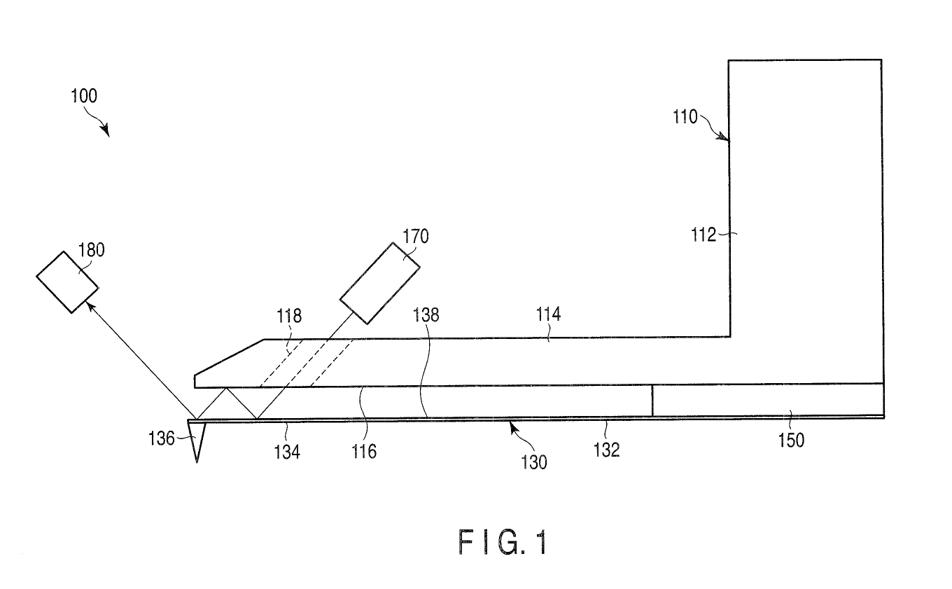

As shown in FIG. 1, an optical-lever cantilever displacement detecting mechanism 100 includes a support member 110, a cantilever 130 cantilevered by the support member 110, a light source 170 to emit a light beam, and an optical sensor 180 to sense the light beam.

The support member 110 has a base 112, and a fixed reflecting portion 114 protruding from the base 112. The fixed reflecting portion 114 extends to face the cantilever 130 with a space from the cantilever 130.

The fixed reflecting portion 114 has a light transmitting portion 118 to allow the light beam to pass therethrough. The light transmitting portion 118 is constituted by, for example, a through-hole. The fixed reflecting portion 114 has a reflecting surface 116 on a side facing the cantilever 130.

The cantilever 130 is joined to the support member 110 through a spacer 150 defining the distance between the cantilever 130 and the fixed reflecting portion 114. The cantilever 130, which is shaped like a flat plate, has a reflecting surface 138 on a side facing the fixed reflecting portion 114.

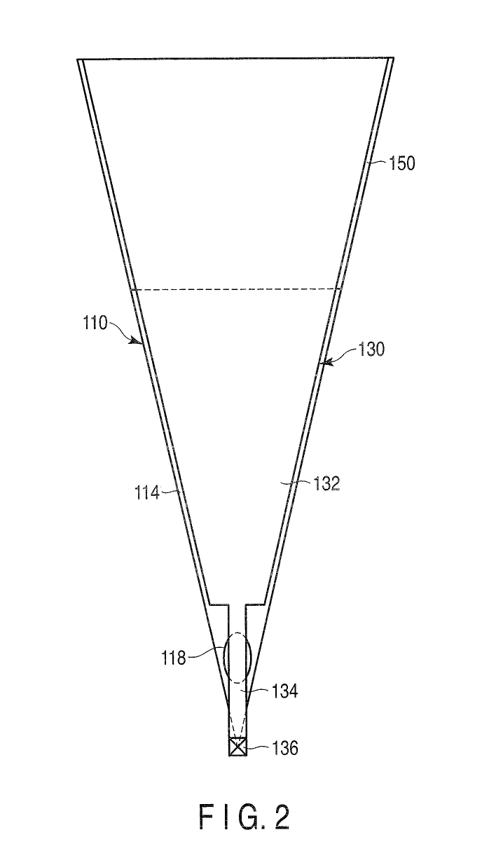

As shown in FIG. 2, the fixed reflecting portion 114 has a shape of an isosceles triangle as viewed from the front. The cantilever 130 has a base 132 having the shape of an isogonal trapezoid as viewed from the front, and a rectangular extension 134 extending from the center of a shorter bottom of the base 132. The isogonal trapezoid refers to a trapezoid in which angles on both sides of the bottom are equal to each other. That is, the isogonal trapezoid is a quadrilateral in which a pair of opposite sides are parallel, another pair of opposite sides are equal in length, and the sum of opposite angles is 180 degrees. The isogonal trapezoid is in the shape of, for example, an isosceles triangle the vertical angle of which is cut by a straight line parallel to the base. It should be noted that the isogonal trapezoid may include a rectangle. The base 132 is one size smaller than the fixed reflecting portion 114, and the tip of the extension 134 protrudes more than the tip of the fixed reflecting portion 114.

As shown in FIG. 1 and FIG. 2, the cantilever 130 has a probe 136 at its tip, namely, its free end. In other words, the probe 136 is provided at the tip, namely, the free end of the extension 134. The probe 136 is in the shape of, for example, a quadrangular pyramid. The probe 136 extends across the reflecting surface 138 of the cantilever 130, toward the opposite side of the reflecting surface 138 perpendicularly, for example.

As shown in FIG. 1, the light source 170 is aligned with the light transmitting portion 118. Moreover, the optical sensor 180 is disposed toward the free end of the cantilever 130.

As shown in FIG. 1, the light source 170, which comprises a semiconductor laser, for example, emits a light beam. The light beam emitted from the light source 170 strikes the cantilever 130 through the light transmitting portion 118. The light beam that has struck the cantilever 130 is repeatedly reflected by the reflecting surface 138 of the cantilever 130 and the reflecting surface 116 of the fixed reflecting portion 114. The repeated reflections include reflections by the reflecting surface 138 of the cantilever 130. In FIG. 1, the reflecting surface 138 of the cantilever 130 reflects two times, but may reflect two or more times. The light beam that has been reflected by the reflecting surface 138 of the cantilever 130 at the end of the repeated reflections strikes the optical sensor 180. The optical sensor 180 outputs a signal representing a change of the entry position of the light beam caused by a displacement of the cantilever 130, that is, a movement of the cantilever 130. The optical sensor 180 comprises, for example, a two-segment photodiode. In this case, the signal representing a change of the entry position of the light beam is obtained by a difference signal between the outputs of two light receivers. The optical sensor 180 may comprise, for example, a two-segment photodiode, a four-segment photodiode, CMOS, a position sensitive device (PSD), or the like.

Since the light beam is repeatedly reflected between the reflecting surface 138 of the cantilever 130 and the reflecting surface 116 of the fixed reflecting portion 114, an optical path from the cantilever 130 to the optical sensor 180 is bent, so that the optical sensor 180 is located closer to the cantilever 130 than when the cantilever 130 reflects one time. Moreover, since the light beam is reflected by the reflecting surface 138 of the cantilever 130 more than one time, a change of the entry position of the light beam on the optical sensor 180 is amplified as compared with the case where the cantilever 130 reflects one time. Thus, under a condition with the same detection sensitivity, the optical path from the cantilever 130 to the optical sensor 180 is shorter than when the cantilever 130 reflects one time. That is, the optical-lever cantilever displacement detecting mechanism 100 that is reduced in size without sacrificing the detection sensitivity is provided. Both the improvement of the detection sensitivity and the size reduction can be achieved at the same time. Consequently, the optical-lever cantilever displacement detecting mechanism 100 according to the present embodiment can be disposed in a small space, and the degree of freedom in the design of equipment to incorporate this mechanism is improved.

According to the present embodiment, the light beam emitted from the light source 170 strikes the cantilever 130 through the light transmitting portion 118, and the light beam that has been reflected by the reflecting surface 138 of the cantilever 130 at the end of the repeated reflections strikes the optical sensor 180. However, the positions of the light source 170 and the optical sensor 180 may be interchanged. That is, the light beam emitted from the light source 170 may enter the cantilever 130, and the light beam that has been reflected by the reflecting surface 138 of the cantilever 130 at the end of the repeated reflections may enter the optical sensor 180 through the light transmitting portion 118. That is, the light source 170 and the optical sensor 180 may be disposed so that the light beam emitted from the light source 170 is repeatedly reflected by the reflecting surface 138 of the cantilever 130 and the reflecting surface 116 of the fixed reflecting portion 114, passes through the light transmitting portion 118, and strikes the optical sensor 180.

### Second Embodiment

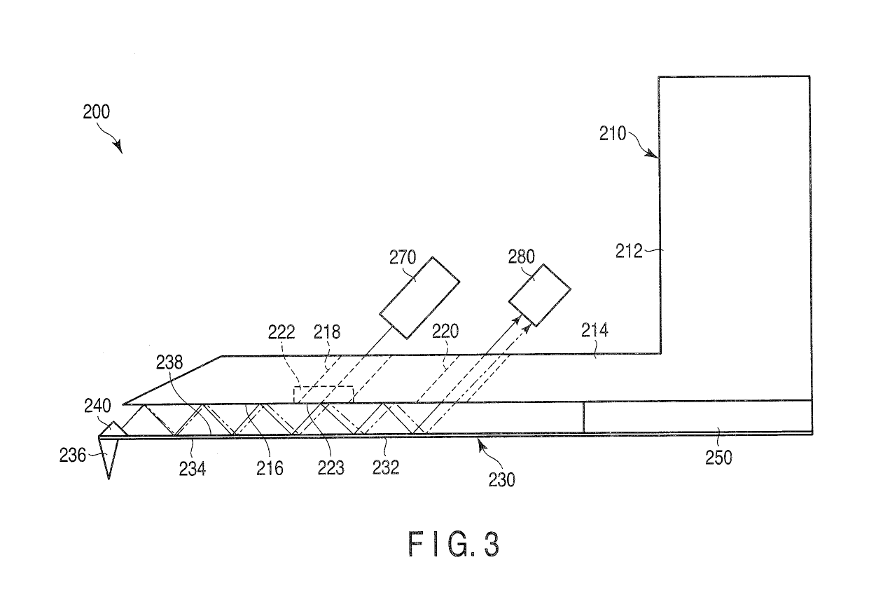

As shown in FIG. 3, an optical-lever cantilever displacement detecting mechanism 200 includes a support member 210, a cantilever 230 cantilevered by the support member 210, a light source 270 to emit a light beam, and an optical sensor 280 to sense the light beam. The light source 270 and the optical sensor 280 are similar to the light source 170 and the optical sensor 180 according to the first embodiment, respectively.

The support member 210 has a base 212, and a fixed reflecting portion 214 protruding from the base 212. The fixed reflecting portion 214 extends to face the cantilever 230 with a space from the cantilever 230. The fixed reflecting portion 214 has two light transmitting portions 218 and 220 to allow the light beam to pass therethrough. The light transmitting portions 218 and 220 comprise, for example, through-holes. The fixed reflecting portion 214 has a reflecting surface 216 on a side facing the cantilever 230. The fixed reflecting portion 214 also has a half mirror 222 provided in the light transmitting portion 218. The reflecting surface of the half mirror 222 is flush with the reflecting surface 216 of the fixed reflecting portion 214, and the half mirror 222 contributes to later-described repeated reflections together with the reflecting surface 216 of the fixed reflecting portion 214.

The cantilever 230 is joined to the support member 210 through a spacer 250 defining the distance between the cantilever 230 and the fixed reflecting portion 214. The cantilever 230, which is shaped like a flat plate, has a reflecting surface 238 on a side facing the fixed reflecting portion 214

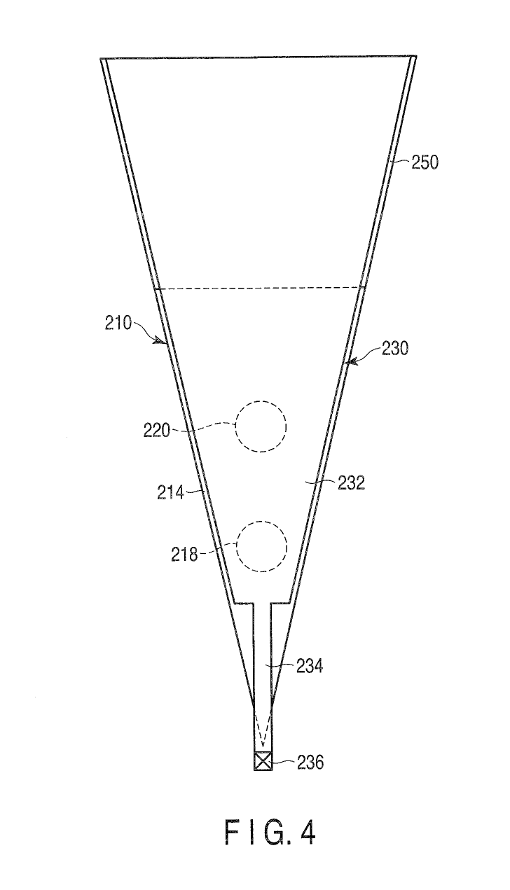

As shown in FIG. 4, the fixed reflecting portion 214 is in the shape of an isosceles triangle as viewed from the front. The cantilever 230 has a base 232 having a shape of an isogonal trapezoid as viewed from the front, and a rectangular extension 234 extending from the center of a shorter bottom of the base 232. The base 232 is one size smaller than the fixed reflecting portion 214, and the tip of the extension 234 protrudes more than the tip of the fixed reflecting portion 214.

As shown in FIG. 3 and FIG. 4, the cantilever 230 has a probe 236 at its tip, namely, its free end. In other words, the probe 236 is provided at the tip, namely, the free end of the extension 234. The probe 236 has a shape of, for example, a quadrangular pyramid. The probe 236 extends across the reflecting surface 238 of the cantilever 230, toward the opposite of the reflecting surface 238 perpendicularly, for example.

As shown in FIG. 3, the cantilever 230 has a back-reflecting portion 240 to reflect the light beam back in the opposite direction on the side of the reflecting surface 238 near the probe 236.

The light source 270 is aligned with the light transmitting portion 218. Moreover, the optical sensor 280 is aligned with the light transmitting portion 220.

In FIG. 3, the light beam emitted from the light source 270 strikes the half mirror 222 through the light transmitting portion 218, and part of the light beam penetrates the half mirror 222 and then strikes the cantilever 230. The light beam that has struck the cantilever 230 is repeatedly reflected by the reflecting surface 238 of the cantilever 230 and the reflecting surface 216 of the fixed reflecting portion 214, and reaches the back-reflecting portion 240. The light beam that has reached the back-reflecting portion 240 is reflected back by the back-reflecting portion 240 in the opposite direction, repeatedly reflected by the reflecting surface 238 of the cantilever 230, a reflecting surface 224 of the half mirror 222, and the reflecting surface 216 of the fixed reflecting portion 214, and strikes the optical sensor 280 through the light transmitting portion 220. The optical sensor 280 outputs a signal representing a change of the entry position of the light beam caused by a displacement of the cantilever 230, that is, a movement of a beam spot.

The optical-lever cantilever displacement detecting mechanism 200 according to the present embodiment has the following advantages in addition to the same advantages as the optical-lever cantilever displacement detecting mechanism 100 according to the first embodiment.

In a conventional optical-lever cantilever displacement detecting mechanism, a light source and an optical sensor are respectively disposed on both sides of a plane that is perpendicular to the longitudinal axis of a cantilever and that traverses a probe. However, in the optical-lever cantilever displacement detecting mechanism 200 according to the present embodiment, both the light source 270 and the optical sensor 280 are disposed on one side of a plane that is perpendicular to the longitudinal axis of the cantilever 230 and that traverses the probe 236. Thus, the optical-lever cantilever displacement detecting mechanism 200 according to the present embodiment is further reduced in size. Here, the longitudinal axis of the cantilever 230 refers to a straight line extending through the center of the fixed end of the cantilever 230 and the center of the free end thereof.

According to the present embodiment, the light beam emitted from the light source 270 strikes the cantilever 230 through the light transmitting portion 218, and the light beam that has been reflected by the reflecting surface 238 of the cantilever 230 at the end of the repeated reflections strikes the optical sensor 280 through the light transmitting portion 220. However, the positions of the light source 270 and the optical sensor 280 may be interchanged. That is, the light beam emitted from the light source 270 may enter the cantilever 230 through the light transmitting portion 220, and the light beam that has been reflected by the reflecting surface 238 of the cantilever 230 in the process of the repeated reflections may enter the optical sensor 280 through the light transmitting portion 218. That is, the light source 270 and the optical sensor 280 may be disposed so that the light beam emitted from the light source 270 strikes the cantilever 230 through one of the two light transmitting portions 218 and 220, repeatedly reflected by the reflecting surface 238 of the cantilever 230, a reflecting surface 224 of the half mirror 222, and the reflecting surface 216 of the fixed reflecting portion 214, reflected back by the back-reflecting portion 240, passes through the half mirror 222, and strikes the optical sensor 280 through the other of the two light transmitting portions 218 and 220.

### Third Embodiment

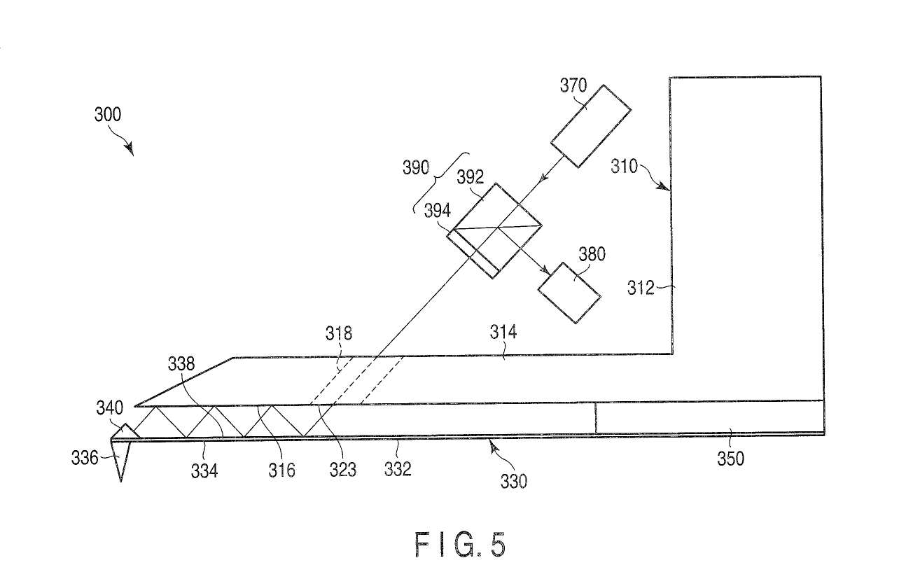

As shown in FIG. 5, an optical-lever cantilever displacement detecting mechanism 300 includes a support member 310, a cantilever 330 cantilevered by the support member 310, a light source 370 to emit a light beam, an optical sensor 380 to sense the light beam, and a beam splitter 390 to couple and decouple the optical paths of the light beam. The light source 370 and the optical sensor 380 are similar to the light source 170 and the optical sensor 180 according to the first embodiment, respectively.

The support member 310 has a base 312, and a fixed reflecting portion 314 protruding from the base 312. The fixed reflecting portion 314 extends to face the cantilever 330 with a space from the cantilever 330. The fixed reflecting portion 314 has a light transmitting portion 318 to allow the light beam to pass therethrough. The light transmitting portion 318 comprises, for example, a through-hole. The fixed reflecting portion 314 has a reflecting surface 316 on a side facing the cantilever 330.

The cantilever 330 is joined to the support member 310 through a spacer 350 defining the distance between the cantilever 330 and the fixed reflecting portion 314. The cantilever 330, which is shaped like a flat plate, has a reflecting surface 338 on a side facing the fixed reflecting portion 314.

The cantilever 330 has a probe 336 at its tip, namely, its free end. The probe 336 extends across the reflecting surface 338 of the cantilever 330, toward the opposite side of the reflecting surface 338 perpendicularly, for example. The cantilever 330 also has a back-reflecting portion 340 to reflect reflects the light beam back in the opposite direction on the side of the reflecting surface 338 near the probe 336. In other respects, details of the cantilever 330 are similar to those of the cantilever 230 according to the second embodiment.

The light source 370 is aligned with the light transmitting portion 318. The beam splitter 390 is located between the light source 370 and the light transmitting portion 318. The beam splitter 390 transmits a light beam emitted from the light source 370, and reflects, to the optical sensor 380, the light beam returning through the light transmitting portion 318.

The beam splitter 390 comprises, for example, a polarizing beam splitter 392 and a quarter-wave plate 394. The polarizing beam splitter 392 transmits linearly polarized light emitted from the light source 370, and reflects linearly polarized light the polarization plane of which is perpendicular to the polarizing beam splitter 392. The quarter-wave plate 394 is located, for example, to be in contact with the surface of the polarizing beam splitter 392 opposite to the light source 370. The quarter-wave plate 394 does not necessarily have to be located to be in contact with the surface of the polarizing beam splitter 392, and has only to be located on the optical path between the beam splitter 390 and the back-reflecting portion 340.

The light beam emitted from the light source 370 penetrates the beam splitter 390, and strikes the cantilever 330 through the light transmitting portion 318. The light beam that has struck the cantilever 330 is repeatedly reflected by the reflecting surface 338 of the cantilever 330 and the reflecting surface 316 of the fixed reflecting portion 314, and reaches the back-reflecting portion 340. The light beam that has reached the back-reflecting portion 340 is reflected back by the back-reflecting portion 340 in the opposite direction, repeatedly reflected by the reflecting surface 338 of the cantilever 330 and the reflecting surface 316 of the fixed reflecting portion 314, and enters the beam splitter 390 through the light transmitting portion 318. The light beam that has struck the beam splitter 390 is reflected by the beam splitter 390, and strikes the optical sensor 380. The optical sensor 380 outputs a signal representing a change of the entry position of the light beam caused by a displacement of the cantilever 330, that is, a movement of a beam spot.

The optical-lever cantilever displacement detecting mechanism 300 according to the present embodiment has the same advantages as the optical-lever cantilever displacement detecting mechanism 200 according to the second embodiment. Moreover, when the beam splitter 390 is configured by a combination of the polarizing beam splitter 392 and the quarter-wave plate 394, there is substantially no loss of the light beam, so that a displacement of the cantilever 330 can be detected with a high SN ratio.

According to the present embodiment, the light beam emitted from the light source 370 penetrates the beam splitter 390 and then travels to the light transmitting portion 318, and the light beam returning through the light transmitting portion 318 is reflected to the optical sensor 380 by the beam splitter 390. However, the positions of the light source 370 and the optical sensor 380 may be interchanged. That is, the light beam emitted from the light source 370 may be reflected to the light transmitting portion 318 by the beam splitter 390, and the light beam returning through the light transmitting portion 318 may penetrate the beam splitter 390 and then travel to the optical sensor 380. That is, the beam splitter 390 has only to direct, to the light transmitting portion 318, the light beam emitted from the light source 370, and direct, to the optical sensor 380, the light beam that has passed through the light transmitting portion 318, undergone the repeated reflections to reach the back-reflecting portion 340, been reflected back by the back-reflecting portion 340 in the opposite direction, again undergone the repeated reflections, and passed through the light transmitting portion 318.

### Fourth Embodiment

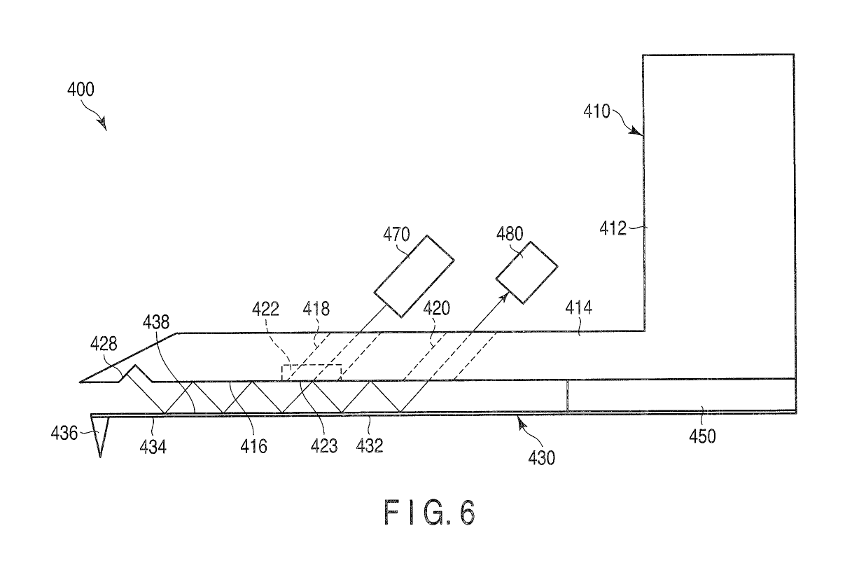

As shown in FIG. 6, an optical-lever cantilever displacement detecting mechanism 400 includes a support member 410, a cantilever 430 cantilevered by the support member 410, a light source 470 to emit a light beam, and an optical sensor 480 to sense the light beam. The light source 470 and the optical sensor 480 are similar to the light source 170 and the optical sensor 180 according to the first embodiment, respectively.

The support member 410 has a base 412, and a fixed reflecting portion 414 protruding from the base 412. The fixed reflecting portion 414 extends to face the cantilever 430 with a space from the cantilever 430. The fixed reflecting portion 414 has two light transmitting portions 418 and 420 to allow the light beam to pass therethrough. The light transmitting portions 418 and 420 comprise, for example, through-holes. The fixed reflecting portion 414 has a reflecting surface 416 on a side facing the cantilever 430. The fixed reflecting portion 414 also has a half mirror 422 provided in the light transmitting portion 418. The reflecting surface of the half mirror 422 is flush with the reflecting surface 416 of the fixed reflecting portion 414, and the half mirror 422 contributes to later-described repeated reflections together with the reflecting surface 416 of the fixed reflecting portion 414.

The cantilever 430 is joined to the support member 410 through a spacer 450 defining the distance between the cantilever 430 and the fixed reflecting portion 414. The cantilever 430, which is shaped like a flat plate, has a reflecting surface 438 on a side facing the fixed reflecting portion 414.

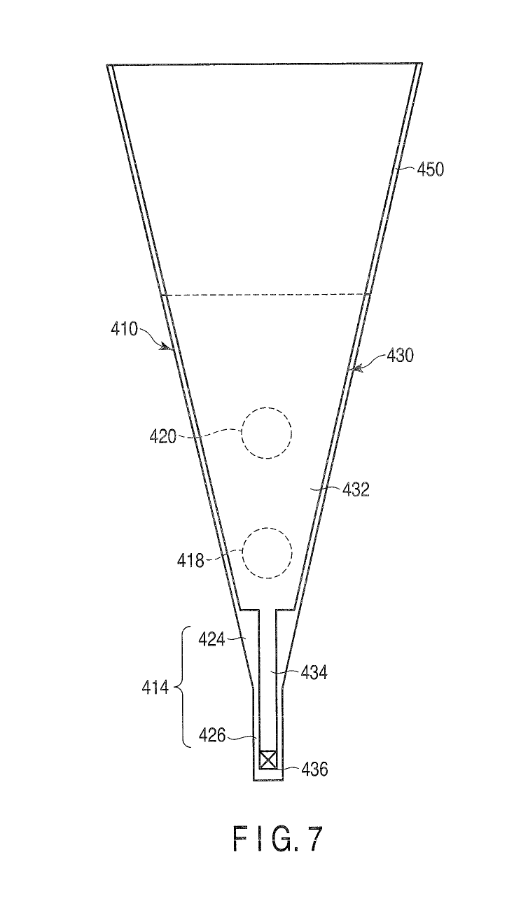

As shown in FIG. 7, the fixed reflecting portion 414 has a base 424 having a shape of an isogonal trapezoid as viewed from the front, and a rectangular extension 426 extending from the center of a shorter bottom of the base 424. The cantilever 430 has a base 432 having a shape of an isogonal trapezoid as viewed from the front, and a rectangular extension 434 extending from the center of a shorter bottom of the base 432. The base 424 of the fixed reflecting portion 414 is one size smaller than the base 432 of the cantilever 430, and the tip of the extension 426 of the fixed reflecting portion 414 protrudes more than the tip of the extension 434 of the cantilever 430.

As shown in FIG. 6 and FIG. 7, the cantilever 430 has a probe 436 at its tip, namely, its free end. In other words, the probe 436 is provided at the tip, namely, the free end of the extension 434. The probe 436 has a shape of, for example, a quadrangular pyramid. The probe 436 extends across the reflecting surface 438 of the cantilever 430, toward the opposite of the reflecting surface 438 perpendicularly, for example.

As shown in FIG. 6, the fixed reflecting portion 414 has, in the extension 426, a back-reflecting portion 428 reflecting the light beam back in the opposite direction. The back-reflecting portion 428 is located near the probe 436.

The light source 470 is aligned with the light transmitting portion 418. Moreover, the optical sensor 480 is aligned with the light transmitting portion 420.

In FIG. 6, the light beam emitted from the light source 470 strikes the half mirror 422 through the light transmitting portion 418, and part of the light beam penetrates the half mirror 422 and then strikes the cantilever 430. The light beam that has struck the cantilever 430 is repeatedly reflected by the reflecting surface 438 of the cantilever 430 and the reflecting surface 416 of the fixed reflecting portion 414, and reaches the back-reflecting portion 428. The light beam that has reached the back-reflecting portion 428 is reflected back by the back-reflecting portion 428 in the opposite direction, repeatedly reflected by the reflecting surface 438 of the cantilever 430, a reflecting surface 423 of the half mirror 422, and the reflecting surface 416 of the fixed reflecting portion 414, and strikes the optical sensor 480 through the light transmitting portion 420. The optical sensor 480 outputs a signal representing a change of the entry position of the light beam caused by a displacement of the cantilever 430, that is, a movement of a beam spot.

The optical-lever cantilever displacement detecting mechanism 400 according to the present embodiment has the same advantages as the optical-lever cantilever displacement detecting mechanism 200 according to the second embodiment.

The present embodiment can be said to be an alteration/modification of the second embodiment in that the back-reflecting portion 240 is provided in the fixed reflecting portion 214 rather than in the cantilever 230. A similar alteration/modification may also be made to the third embodiment.

In the present embodiment, the positions of the light source 470 and the optical sensor 480 may be interchanged, as in the second embodiment.

### Fifth Embodiment

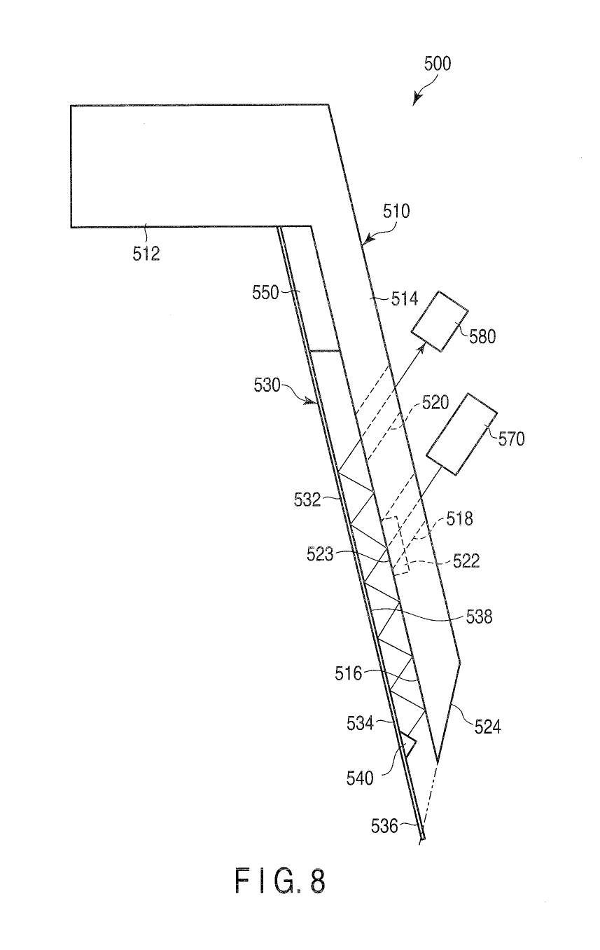

As shown in FIG. 8, an optical-lever cantilever displacement detecting mechanism 500 includes a support member 510, a cantilever 530 cantilevered by the support member 510, a light source 570 to emit a light beam, and an optical sensor 580 to sense the light beam. The light source 570 and the optical sensor 580 are similar to the light source 170 and the optical sensor 180 according to the first embodiment, respectively.

The support member 510 has a base 512, and a fixed reflecting portion 514 protruding from the base 512. The fixed reflecting portion 514 extends from the end of the base 512 diagonally opposite to the base 512. The fixed reflecting portion 514 extends to face the cantilever 530 with a space from the cantilever 530. The fixed reflecting portion 514 has two light transmitting portions 518 and 520 to allow the light beam to pass therethrough. The light transmitting portions 518 and 520 comprise, for example, through-holes. The fixed reflecting portion 514 has a reflecting surface 516 on a side facing the cantilever 530. The fixed reflecting portion 514 also has a half mirror 522 provided in the light transmitting portion 518. The reflecting surface of the half mirror 522 is flush with the reflecting surface 516 of the fixed reflecting portion 514, and the half mirror 522 contributes to later-described repeated reflections together with the reflecting surface 516 of the fixed reflecting portion 514.

The cantilever 530 is joined to the support member 510 through a spacer 550 defining the distance between the cantilever 530 and the fixed reflecting portion 514. The cantilever 530, which is shaped like a flat plate, has a reflecting surface 538 on a side facing the fixed reflecting portion 514.

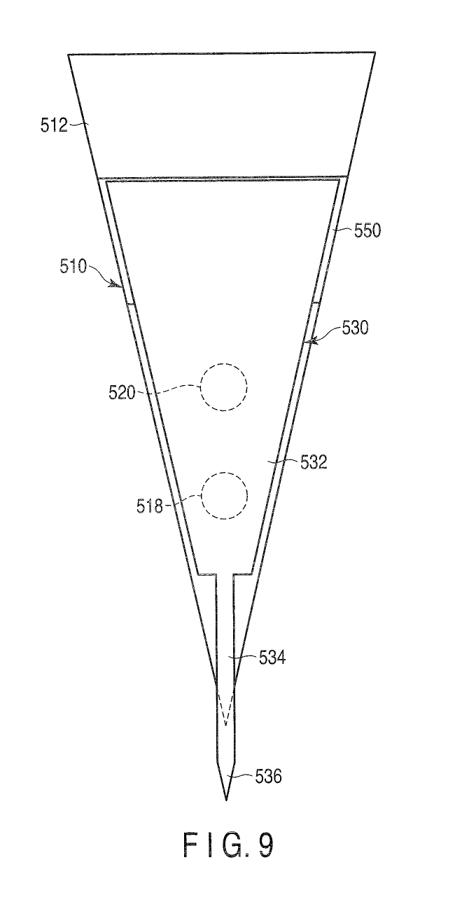

As shown in FIG. 9, the fixed reflecting portion 514 has a shape of an isosceles triangle as viewed from the front. The cantilever 530 has a base 532 having a shape of an isogonal trapezoid as viewed from the front, a rectangular extension 534 extending from the center of a shorter bottom of the base 532, and a probe 536 in the shape of an isosceles triangle extending from the tip of the extension 534. The base 532 is one size smaller than the fixed reflecting portion 514, and the extension 534 protrudes more than the tip of the fixed reflecting portion 514.

As shown in FIG. 8, the probe 536 extends parallel to the longitudinal axis of the cantilever 530. The cantilever 530 also has, in the extension 534 located near the probe 536, a back-reflecting portion 540 to reflect the light beam back in the opposite direction on the side of the fixed reflecting portion 514. An edge 526 at the tip of the fixed reflecting portion 514 makes an acute angle with the reflecting surface 516. The tip of the probe 536 protrudes in the forward direction of the longitudinal axis more than a straight line that passes through the edge 526. Here, the forward direction of the longitudinal axis refers to a direction parallel to the longitudinal axis from a fixed end to a free end.

The light source 570 is aligned with the light transmitting portion 518. Moreover, the optical sensor 580 is aligned with the light transmitting portion 520.

In FIG. 8, the light beam emitted from the light source 570 strikes the half mirror 522 through the light transmitting portion 518, and part of the light beam penetrates the half mirror 522 and then strikes the cantilever 530. The light beam that has struck the cantilever 530 is repeatedly reflected by the reflecting surface 538 of the cantilever 530 and the reflecting surface 516 of the fixed reflecting portion 514, and reaches the back-reflecting portion 540. The light beam that has reached the back-reflecting portion 540 is reflected back by the back-reflecting portion 540 in the opposite direction, repeatedly reflected by the reflecting surface 538 of the cantilever 530, a reflecting surface 524 of the half mirror 522, and the reflecting surface 516 of the fixed reflecting portion 514, and strikes the optical sensor 580 through the light transmitting portion 520. The optical sensor 580 outputs a signal representing a change of the entry position of the light beam caused by a displacement of the cantilever 530, that is, a movement of a beam spot.

The optical-lever cantilever displacement detecting mechanism 500 according to the present embodiment has the following advantages in addition to the same advantages as the optical-lever cantilever displacement detecting mechanism 200 according to the second embodiment.

The probe 536 extends parallel to the longitudinal axis of the cantilever 530, and the edge 526 at the tip of the fixed reflecting portion 514 makes an acute angle with the reflecting surface 516, so that a space around the axis of the probe 536 is free. Here, the axis of the probe 536 refers to a straight line that passes the center of the fixed end of the probe 536 and the tip thereof. Therefore, the optical-lever cantilever displacement detecting mechanism 500 according to the present embodiment is suitably used in combination with a long-stroke and high-precision stage to configure a surface shape measurement device. The surface shape measurement device comprising the optical-lever cantilever displacement detecting mechanism 500 according to the present embodiment can highly precisely measure even a measurement target that is greatly curved in its entire surface, such as a lens or its die.

In the present embodiment, the positions of the light source 570 and the optical sensor 580 may be interchanged, as in the second embodiment.

### Sixth Embodiment

As shown in FIG. 9, an optical-lever cantilever displacement detecting mechanism 600 includes a support member 610, a cantilever 630 cantilevered by the support member 610, a light source 670 to emit a light beam, and an optical sensor 680 to sense the light beam. The light source 670 and the optical sensor 680 are similar to the light source 170 and the optical sensor 180 according to the first embodiment, respectively.

The support member 610 has a base 612, and a fixed reflecting portion 614 protruding from the base 612. The fixed reflecting portion 614 extends from the end of the base 612 diagonally to the base 612. The fixed reflecting portion 614 extends to face the cantilever 630 with a space from the cantilever 630. The fixed reflecting portion 614 has two light transmitting portions 618 and 620 to allow the light beam to pass therethrough. The light transmitting portions 618 and 620 comprise, for example, through-holes. The fixed reflecting portion 614 has a reflecting surface 616 on a side facing the cantilever 630. The fixed reflecting portion 614 also has a half mirror 622 provided in the light transmitting portion 618. The reflecting surface of the half mirror 622 is flush with the reflecting surface 616 of the fixed reflecting portion 614, and the half mirror 622 contributes to later-described repeated reflections together with the reflecting surface 616 of the fixed reflecting portion 614.

The cantilever 630 is joined to the support member 610 through a spacer 650 defining the distance between the cantilever 630 and the fixed reflecting portion 614. The cantilever 630, which is shaped like a flat plate, has a reflecting surface 638 on a side facing the fixed reflecting portion 614.

The probe 636 extends parallel to the longitudinal axis of the cantilever 630. The cantilever 630 also has, in an extension 634 located near the probe 636, a back-reflecting portion 640 to reflect the light beam back in the opposite direction on the side of the fixed reflecting portion 614. An edge 626 at the tip of the fixed reflecting portion 614 makes an acute angle with the reflecting surface 616. The tip of the probe 636 protrudes in the forward direction of the longitudinal axis more than a straight line that passes through the edge 626. In other respects, details of the cantilever 630 are similar to those of the cantilever 530 according to the fifth embodiment.

The light source 670 is aligned with the light transmitting portion 618. Moreover, the optical sensor 680 is aligned with the light transmitting portion 620.

The light beam emitted from the light source 670 strikes the half mirror 622 through the light transmitting portion 618, and part of the light beam penetrates the half mirror 622 and then strikes the cantilever 630. The light beam that has struck the cantilever 630 is repeatedly reflected by the reflecting surface 638 of the cantilever 630 and the reflecting surface 616 of the fixed reflecting portion 614, and reaches the back-reflecting portion 640. The light beam that has reached the back-reflecting portion 640 is reflected back by the back-reflecting portion 640 in the opposite direction, repeatedly reflected by the reflecting surface 638 of the cantilever 630, a reflecting surface 624 of the half mirror 622, and the reflecting surface 616 of the fixed reflecting portion 614, and strikes the optical sensor 680 through the light transmitting portion 620. The optical sensor 680 outputs a signal representing a change of the entry position of the light beam caused by a displacement of the cantilever 630, that is, a movement of a beam spot.

The optical-lever cantilever displacement detecting mechanism 600 according to the present embodiment has the same advantages as the optical-lever cantilever displacement detecting mechanism 500 according to the fifth embodiment.

In the present embodiment, the positions of the light source 670 and the optical sensor 680 may be interchanged, as in the second embodiment.

While the embodiments of the present invention have been described above with reference to the drawings, the present invention is not limited to these embodiments, and various modifications and alterations may be made without departing from the spirit thereof. For example, the following modifications and alterations also fall within the scope of the present invention.

The number of repeated reflections is not limited to the illustrations in the drawings, and may be freely changed.

The fixed reflecting portion may comprise components.

The reflecting surface of the fixed reflecting portion is not exclusively a flat surface, and may be a spherical surface or a free-form surface.

An optical axis is normally adjusted by adjusting the position of the light source or the optical sensor. However, the position of the fixed reflecting portion may be made adjustable so that the optical axis is adjusted by adjusting the position of the fixed reflecting portion.

The spacer may be constituted by a vibration generating source such as a piezoelectric element.

The light source may have a structure further including a light guiding member such as an optical fiber.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical-lever cantilever displacement detecting mechanism comprising:
a support member;
a cantilever cantilevered by the support member;
a light source to emit a light beam; and
an optical sensor to sense the light beam,
the cantilever having a probe at its tip, the support member having a fixed reflecting portion extending to face the cantilever with a space from the cantilever, the fixed reflecting portion having a light transmitting portion to allow the light beam to pass therethrough, the cantilever and the fixed reflecting portion having reflecting surfaces on sides facing each other, respectively,
wherein the light beam emitted from the light source undergoes repeated reflections by the reflecting surface of the cantilever and the reflecting surface of the fixed reflecting portion including reflections by the reflecting surface of the cantilever, passes through the light transmitting portion, and strikes the optical sensor, and
the optical sensor outputs a signal representing a change of the entry position of the light beam caused by a displacement of the cantilever.

2. The optical-lever cantilever displacement detecting mechanism according to claim 1, wherein
one of the cantilever and the fixed reflecting portion includes a back-reflecting portion to reflect the light beam back in the opposite direction, the back-reflecting portion being located near the probe,
the optical-lever cantilever displacement detecting mechanism further comprises a beam splitter, the beam splitter directing, to the light transmitting portion, the light beam emitted from the light source, and directing, to the optical sensor, the light beam that has passed through the light transmitting portion, undergone the repeated reflections to reach the back-reflecting portion, been reflected back by the back-reflecting portion in the opposite direction, again undergone the repeated reflections, and passed through the light transmitting portion.

3. The optical-lever cantilever displacement detecting mechanism according to claim 1, wherein
one of the cantilever and the fixed reflecting portion includes a back-reflecting portion to reflect the light beam back in the opposite direction, the back-reflecting portion being located near the probe,
the fixed reflecting portion further includes a half mirror provided in the light transmitting portion, the reflecting surface of the half mirror being flush with the reflecting surface of the fixed reflecting portion, the half mirror contributing to the repeated reflections together with the reflecting surface of the fixed reflecting portion, the fixed reflecting portion further having, closer to a fixed end than the light transmitting portion, another light transmitting portion to allow the light beam to pass therethrough, and
the light beam emitted from the light source strikes the cantilever through one of the two light transmitting portions, undergone the repeated reflections by the reflecting surface of the cantilever, the reflecting surface of the half mirror, and the reflecting surface of the fixed reflecting portion, been reflected back by the back-reflecting portion, passes through the half mirror, and strikes the optical sensor through the other of the two light transmitting portions.

4. The optical-lever cantilever displacement detecting mechanism according to claim 3, wherein the probe extends across the reflecting surface of the cantilever.

5. The optical-lever cantilever displacement detecting mechanism according to claim 3, wherein the probe extends parallel to a longitudinal axis of the cantilever.

6. The optical-lever cantilever displacement detecting mechanism according to claim 1, wherein the cantilever is joined to the support member through a spacer defining the distance between the cantilever and the fixed reflecting portion.

7. The optical-lever cantilever displacement detecting mechanism according to claim 1, wherein the light source comprises a semiconductor laser.
